(19) United States
(12) Patent Application Publication
(10) Pub. No.: US 2010/0169709 A1
(43) Pub. Date: Jul. 1, 2010

(54) System Of Updating Firmware And Method Thereof, And Method Of Creating Firmware

(75) Inventors: Yi-Tung Chiu, Taipei (TW); Ching-Feng Hsieh, Taipei City (TW); Jen-Huan Yu, Taipei (TW)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: ASKEY COMPUTER CORPORATION, Taipei (TW)

(21) Appl. No.: 12/434,203

(22) Filed: May 1, 2009

(30) Foreign Application Priority Data
Dec. 31, 2008 (TW) 097151559

(51) Int. Cl. G06F 9/44; G06F 11/10; G06F 11/14; G06F 12/02

(52) U.S. Cl. 714/16; 714/52; 711/103; 717/168; 711/E12.008; 714/E11.032; 714/E11.117

(57) ABSTRACT

A system and method of updating firmware and a method of creating firmware are provided. The system includes a firmware storage module having first firmware and second firmware. The first and second firmware each have image header file data, including a cyclic redundancy checksum (CRC) and an image header file creation time. The method of updating firmware includes determining whether the first and second firmware have an abnormality according to the CRC information. When an abnormality is present in the first or second firmware, the abnormality-stricken firmware is replaced with new firmware. When the abnormality is absent from the first and second firmware, the first firmware is compared with the second firmware in terms of the image header file creation time such that the firmware with the earlier creation time is replaced by the new firmware. Operable firmware is available even if the firmware updating operation fails.

### BACKGROUND OF THE INVENTION

1. Field of the Invention

The present invention relates generally to firmware updating techniques, and more particularly, to a system of updating firmware and a method thereof, and a method of creating firmware such that, in case a firmware updating operation fails, operable firmware is available to facilitate subsequent firmware updating.

2. Description of Related Art

Computer related products nowadays, such as CD-ROM drives and modems, generally use firmware to start up and execute the hardware. Updateable devices such as non-volatile memories (flash ROMs, or EEPROMs) are used for storing firmware. Unlike their predecessors, firmware updating operations are not performed by manufacturers, but by users through a network from which firmware updating programs are downloaded in order to carry out the firmware updating operations.

Generally, manufacturers provide firmware update files at server ends of the network for users to download. After downloading the firmware update files, the users write (or burn) the downloaded firmware update files into firmware storage memories, using the firmware updating programs, so as to overwrite the original firmware.

To carry out the above-described firmware updating operations, computers at user ends are required to be power-on and running operating systems such as DOS, Windows or Linux.

However, an abnormality such as power failure may occur during a firmware updating operation, thereby causing errors to the firmware updating. In addition, some errors existing in operating systems such as Windows and Linux may cause an abnormality, for example, a system restarts suddenly during a firmware updating operation, thereby causing errors to the firmware updating.

In case an abnormality occurs during a firmware updating operation performed on firmware stored in a device (e.g., CD-ROM drives) or system, the device or system cannot continue to operate because the original firmware stored therein has been overwritten and deleted and the new firmware is corrupted. In many cases, updating files downloaded by users through a network cannot be written to the device or system again because the functioning cooperation of the device or system is typically required to process an update, but such cooperation may be unavailable if the device or system is currently configured with corrupt firmware. If corrupt firmware was written and cannot be rewritten with valid firmware, the device or system is said to be “bricked,” meaning that it no longer electrically functions and is essentially like a paperweight. In such a case, the device or system must be repaired and updated by the manufacturers, thereby bringing inconvenience to the users and manufacturers.

Therefore, there is a need to provide a firmware updating technique and a firmware creating technique such that even if an abnormality occurs during a firmware updating operation performed on firmware stored in a device or system, the device or system can perform firmware updating in follow-up operations.

### SUMMARY OF THE INVENTION

According to the above drawbacks, the present invention provides a system and a method of updating firmware and a method of creating firmware for use with the system of updating firmware such that even if an abnormality occurs during a firmware updating operation performed on firmware stored in a device or system, the device or system can perform firmware updating in follow-up operations.

In order to achieve the above and other objectives, the present invention provides a system of updating firmware for use with an electronic device. The system comprises: a firmware storage module disposed in the electronic device for at least storing a first firmware version and a second firmware version, wherein the first firmware and the second firmware versions each have image header file data that at least comprises a cyclic redundancy checksum (CRC) and an image header file creation time; a receiving module for receiving an instruction for executing a firmware update so as to obtain new firmware; a determining module for receiving the instruction for executing firmware update so as to determine whether the new firmware obtained by the receiving module has an abnormality according to the cyclic redundancy checksum thereof, wherein, if it does, the firmware updating operation is ended, and otherwise, the determining module further determines whether the first firmware and the second firmware have an abnormality according to the cyclic redundancy checksum thereof stored in the firmware storage module, wherein, if only one of the first firmware and the second firmware versions has an abnormality, the abnormal-stricken firmware is locked as target firmware, or, if both the first firmware and the second firmware versions are abnormality-stricken, the firmware updating operation is ended, but if both the first firmware and the second firmware are abnormality-free, the image header file creation time of the first firmware is compared with that of the second firmware such that the firmware with the earlier image header file creation time is locked as target firmware; and an updating module that replaces the target firmware locked by the determining module with the new firmware so as to complete the firmware updating operation.

The system of updating firmware further comprises a firmware executing module for re-executing executable firmware of the electronic device.

Before the firmware executing module re-executes executable firmware, the determining module determines whether the first firmware and the second firmware versions after the firmware updating operation have an abnormality according to the cyclic redundancy checksum of the first firmware and the second firmware stored in the firmware storage module, wherein, if one of the first firmware and the second firmware has an abnormality, the abnormality-free firmware is locked as executable firmware, but if both the first firmware and the second firmware are abnormality-free, the image header file creation time of the first firmware version is compared with that of the second firmware version such that the firmware with later image header file creation time is locked as executable firmware, otherwise, if both the first firmware and the second firmware versions are abnormality-stricken, the system startup is ended.

The present invention further provides a method of updating firmware of an electronic device, wherein the electronic device has a firmware storage module that at least stores a first firmware version and a second firmware version, wherein the first firmware and the second firmware versions each have image header file data that at least comprises a cyclic redundancy checksum and an image header file creation time. The method of updating firmware comprises: obtaining new firmware upon receipt of an instruction for executing a firmware update; checking the cyclic redundancy checksum of the new firmware for an error, and going to the next step if a determination is made that the cyclic redundancy checksum of the new firmware is error-free; determining whether the first firmware and the second firmware have an abnormality-according to the cyclic redundancy checksum of the first firmware and the second firmware versions so as to lock, upon determination of presence of the abnormality in one of the first firmware and the second firmware versions, the abnormality-stricken firmware as target firmware, and otherwise, upon determination of absence of the abnormity in the first firmware and the second firmware versions, compare the first firmware with the second firmware in terms of the image header file creation times thereof so as to define target firmware by locking the first firmware or the second firmware, whichever has earlier said image header file creation time, and end the firmware updating operation upon determination of the presence of the abnormality in the first firmware and the second firmware; and replacing the locked target firmware with the new firmware, thereby completing the firmware updating operation of the electronic device.

The above-described method further comprises the steps of: after replacing the locked target firmware with the new firmware, restarting the electronic device and determining whether the first firmware and the second firmware versions have an abnormality according to the cyclic redundancy checksums thereof, wherein, if one of the first firmware and the second firmware versions is abnormality-stricken, executing the abnormality-free firmware, and if both the first firmware and the second firmware versions are abnormality-stricken, ending the system startup, but if both the first firmware and the second firmware versions are abnormality-free, comparing the image header file creation times of the first firmware version with that of the second firmware version so as to execute the firmware version with the later image header file creation time.

The image header file data further comprises identification code information such that, in the case that the identification code information of the new firmware is determined to be different from the identification code information of the first firmware or the second firmware, another version of the new firmware is obtained anew.

Before performing the identification code information comparing step, the method further comprises: determining whether the new firmware version has an abnormality according to the cyclic redundancy checksum thereof, wherein, if yes, ending the firmware updating operation, and, otherwise, performing the identification code information comparing step.

The present invention further provides a method of creating firmware for use with a system of updating firmware, which comprises: presetting a maximum length of the data stream for firmware storage; combining kernel file data and file system data to create temporary file data; creating image header file data comprising a cyclic redundancy checksum and an image header file creation time; adding the image header file data to the temporary file data so as to form firmware; and determining whether the actual length of the data stream stored in the firmware is less than the preset maximum length of the data stream for firmware storage so as to increase, upon affirmative determination, the length of the data stream of the temporary file data until the actual length of the data stream stored in the firmware equals the preset maximum length of the data stream for firmware storage.

Therefore, the present invention essentially comprises: obtaining new firmware upon receipt of an instruction for executing a firmware update; checking the cyclic redundancy checksum of the new firmware for an error, and going to the next step if a determination is made that the cyclic redundancy checksum of the new firmware is error-free; determining whether the first firmware and the second firmware versions have an abnormality according to the cyclic redundancy checksum of the first firmware and the second firmware versions so as to lock, upon determination of the presence of the abnormality in one of the first firmware and the second firmware, the abnormality-stricken firmware as target firmware, and, upon determination of absence of an abnormity in the first firmware and the second firmware versions, compare the first firmware with the second firmware versions in terms of the image header file creation times thereof so as to define target firmware by locking the first firmware or the second firmware versions, whichever has the earlier said image header file creation time, and end the firmware updating operation upon determination of presence of the abnormality in both the first firmware and the second firmware; and replacing the locked target firmware with the new firmware so as to complete performing the firmware updating operation on firmware stored in the electronic device. In so doing, the firmware updating operation of the present invention overcomes a drawback of the prior art, that is, a system fails to start because of failure of a firmware updating operation.

### BRIEF DESCRIPTION OF DRAWINGS

FIG. 1 is a block diagram showing the basic structure of a system of updating firmware according to the present invention;

FIGS. 2A and 2B are flow diagrams showing a method of updating firmware according to the present invention; and

FIG. 3 is a flow diagram showing a method of creating firmware for use with the system of updating firmware according to the present invention.

### DETAILED DESCRIPTION OF PREFERRED EMBODIMENTS

The following illustrative embodiments are provided to illustrate the disclosure of the present invention. These and other advantages and effects will be apparent to those skilled in the art after reading the disclosure of this specification.

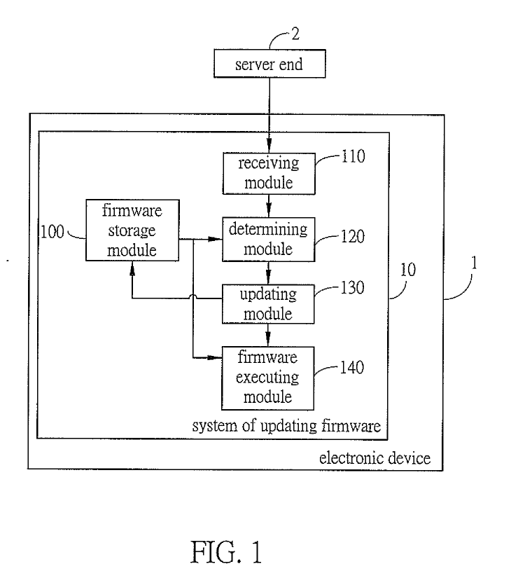

FIG. 1 is a block diagram showing the basic structure of a system of updating firmware according to the present invention. As shown in the drawing, the system 10 is used for updating firmware of an electronic device 1. In particular, the system 10 is used in an electronic device 1 such as a router for updating the firmware thereof according to firmware updating files generated at a server end 2 by using a method of creating firmware.

The system 10 comprises a firmware storage module 100, a receiving module 110, a determining module 120, an updating module 130, and a firmware executing module 140, which are detailed as follows.

The firmware storage module 100 is disposed in the electronic device 1 for at least storing a first firmware and a second firmware version. The first firmware and the second firmware versions have image header file data that at least comprises a cyclic redundancy checksum and an image header file creation time. In the present embodiment, the cyclic redundancy checksum comprises header checksum information, data stream length information, and data checksum information. In the present embodiment, the firmware storage module 100 is a flash ROM, but it is not limited thereto. For example, the firmware storage module 100 can be an EEPROM or other form of non-volatile memory.

The receiving module 110 receives an instruction for executing a firmware update so as to obtain new firmware. In the present embodiment, the receiving module 110 downloads firmware update files from the server end 2 through network transmission, but is not limited thereto. The receiving module 110 can obtain files through other methods such as CD-ROM reading or USB reading.

The determining module 120 receives the instruction for executing a firmware update and determines whether the new firmware obtained by the receiving module 110 has an abnormality according to the cyclic redundancy checksum of the new firmware. If the new firmware is abnormality-stricken, the firmware updating operation is ended, otherwise, the determining module 120 determines whether the first firmware and the second firmware have an abnormality according to the cyclic redundancy checksum thereof stored in the firmware storage module 100, wherein, if one of the first firmware and the second firmware has an abnormality, the abnormality-stricken firmware is locked as target firmware, or, if both the first firmware and the second firmware are abnormal, the firmware updating operation is ended, but if both the first firmware and the second firmware are abnormality-free, the determining module 120 compares the first firmware and the second firmware versions in terms of the image header file creation times thereof stored in the firmware storage module 100 so as to lock the firmware with earlier image header file creation time as target firmware.

The updating module 130 is used to replace the target firmware locked by the determining module 120 and stored in the firmware storage module 100 with the new firmware, thereby completing the firmware updating operation of the electronic device 1.

Finally, the firmware executing module 140 is used to re-execute the executable firmware of the electronic device 1.

In the present embodiment, before the firmware executing module 140 re-executes the executable firmware, the determining module 120 is further used to determine whether, after the firmware updating operation, the first firmware and the second firmware versions have an abnormality according to the cyclic redundancy checksum thereof stored in the firmware storage module 140, wherein, if one of the first firmware and the second firmware is abnormality-stricken, the abnormality-free firmware is locked as executable firmware, or, if both the first firmware and the second firmware are abnormal, the system startup is ended, but if both the first firmware and the second firmware are abnormality-free, the determining module compares the first firmware and the second firmware versions in terms of the image header file creation times thereof stored in the firmware storage module 100 so as to lock the firmware with the later image header file creation time as executable firmware.

Therefore, the system of updating firmware of the present invention chooses the abnormality-stricken firmware or abnormality-free firmware with earlier image header file creation time for updating so as to cause the electronic device keep a newer version of firmware. If the firmware updating operation is successful, the electronic device chooses the newer version of the firmware according to the image header file creation time for execution; otherwise, if the firmware updating operation fails, the electronic device executes the firmware with the earlier image header file creation time, thereby preventing the electronic device from failing to operate due to the failed firmware updating operation and overcoming inconvenience for users and manufactures that exists in the prior art.

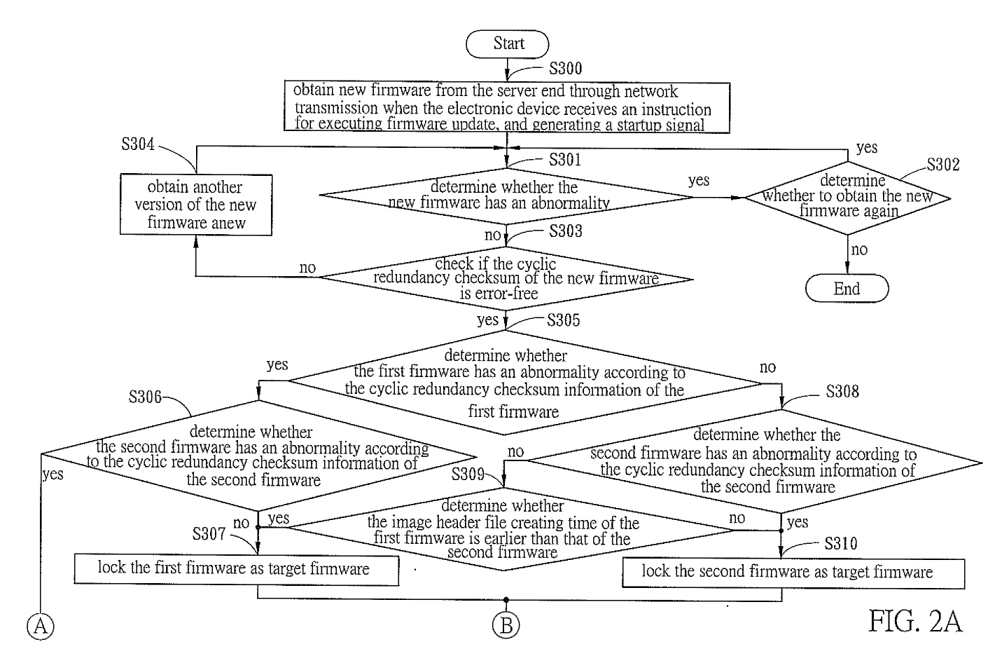

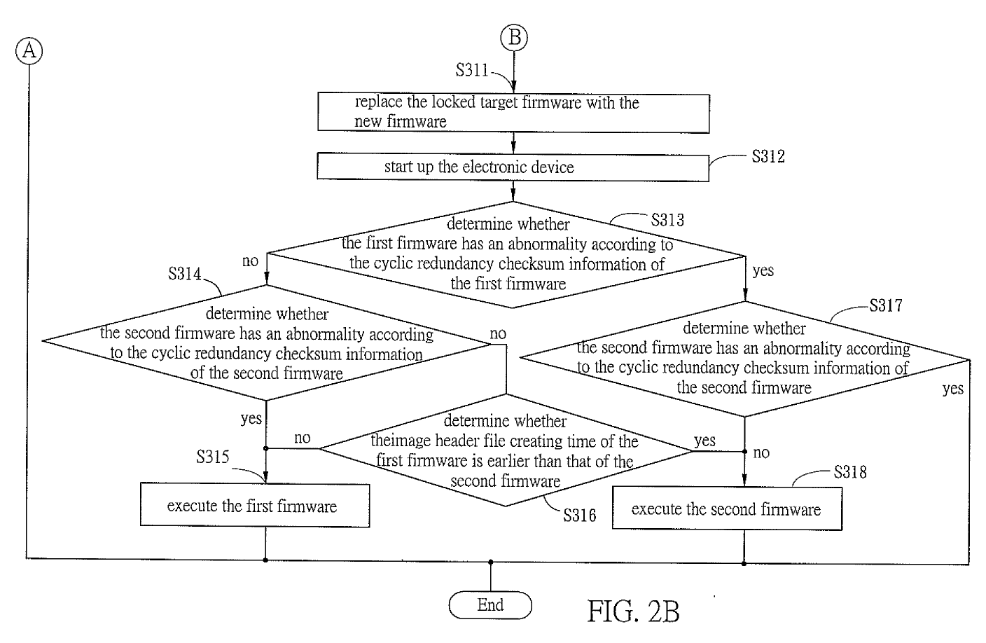

Further, a method of updating firmware using the above-described system is shown in FIGS. 2A and 2B. The method is used for updating firmware in an electronic device 1. The electronic device 1 comprises a firmware storage module 100 that stores a first firmware version and a second firmware version, wherein the first firmware and the second firmware versions each have image header file data at least comprising-a cyclic redundancy checksum and an image header file creation time. The method comprises the following steps.

First, at step S300 in FIG. 2A, when the electronic device 1 receives an instruction for executing a firmware update, it obtains new firmware from a server end 2 through network transmission and generates a startup signal. Therein, the new firmware obtaining method is not limited to network transmission. In other embodiments, the new firmware can be obtained through CD-ROM reading, USB reading and so on. Then, the process goes to step S301.

During the firmware updating operation, an abnormality such as a network transmission failure may cause an incomplete or otherwise corrupted download of the new firmware. Therefore, at step S301, determine whether the new firmware has an abnormality according to the cyclic redundancy checksum of the new firmware, wherein, if it does, the process goes to step S302, otherwise, the process goes to step S303.

At step S302, determine whether to obtain the new firmware again, wherein, if yes, the step goes back to step S301, otherwise, the process is ended. In the present embodiment, if new firmware is still to be obtained, it is downloaded again from the server end 2 through network.

Since the new firmware provided at the server end 2 may have several versions corresponding to their respective manufacturers, users may inadvertently download a wrong version of the new firmware. Therefore, at step S303, the cyclic redundancy checksum of the new firmware is checked to see if it is error-free, wherein, if it is error-free, the process goes to step S305, otherwise, the process goes to step S304.

At step S304, obtain another version of the new firmware anew. In the present embodiment, another version of the new firmware is downloaded from the server end 2 through network. Then, the process goes back to step S301.

At step S305, determining whether the first firmware has an abnormality according to the cyclic redundancy checksum of the first firmware, wherein, if yes, the process goes to step S306, otherwise, the process goes to step S308.

At step S306, determining whether the second firmware has an abnormality according to the cyclic redundancy checksum of the second firmware, wherein, if yes (i.e., both the first firmware and the second firmware versions have abnormalities), the firmware updating operation is ended, otherwise (i.e., only the first firmware version has an abnormality), the process goes to step S307.

At step S307, the first firmware is locked as the target firmware, meaning that it is the firmware to be replaced. Then, the process goes to step S311.

At step S308, determine whether the second firmware has an abnormality according to the cyclic redundancy checksum of the second firmware, wherein, if yes (that is, only the second firmware version has an abnormality), the process goes to step S310, otherwise, both the first firmware and the second firmware are abnormality-free, the process goes to step S309.

At step S309, determine whether the image header file creation time of the first firmware version is earlier than that of the second firmware version, wherein, if yes, the process goes to step S307, and, if no, the process goes to step S310.

At step S310, the second firmware is locked as the target firmware, meaning that it is the firmware to be replaced. Then, the process goes to step S311.

At step S311, the target firmware is replaced with the new firmware so as to complete the firmware updating operation. Then, the process goes to step S312.

At step S312, the electronic device is started up to apply the firmware update. Then, the process goes to step S313.

At step S313, determine whether the first firmware has an abnormality according to the cyclic redundancy checksum of the first firmware, wherein, if yes, the process goes to step S317, and, if no, the process goes to step S314.

At step S314, determine whether the second firmware has an abnormality according to the cyclic redundancy checksum of the second firmware, wherein if yes (i.e., only the second firmware version has an abnormality), the process goes to step S315, otherwise (i.e., both the first firmware and the second firmware are abnormality-free), the process goes to step S316.

At step S315, the first firmware is executed, thereby completing the firmware updating operation.

At step S316, determine whether the image header file creation time of the first firmware is earlier than that of the second firmware, wherein, if yes, the process goes to step S318, otherwise, the process goes to step S315.

At step S317, determine whether the second firmware has an abnormality according to the cyclic redundancy checksum of the second firmware, wherein, if yes, (i.e., both the first firmware and the second firmware versions have abnormalities), the firmware updating operation is ended, otherwise (i.e., only the first firmware has an abnormality), the process goes to step S318.

At step S318, the second firmware is executed, thereby completing the firmware updating operation.

Although at steps S305, S306 and S308, as well as S313, S314, S317, the first firmware is checked for a CRC error before the second firmware is checked, the invention is not limited thereto. In other embodiments, obviously, the second firmware could be checked first.

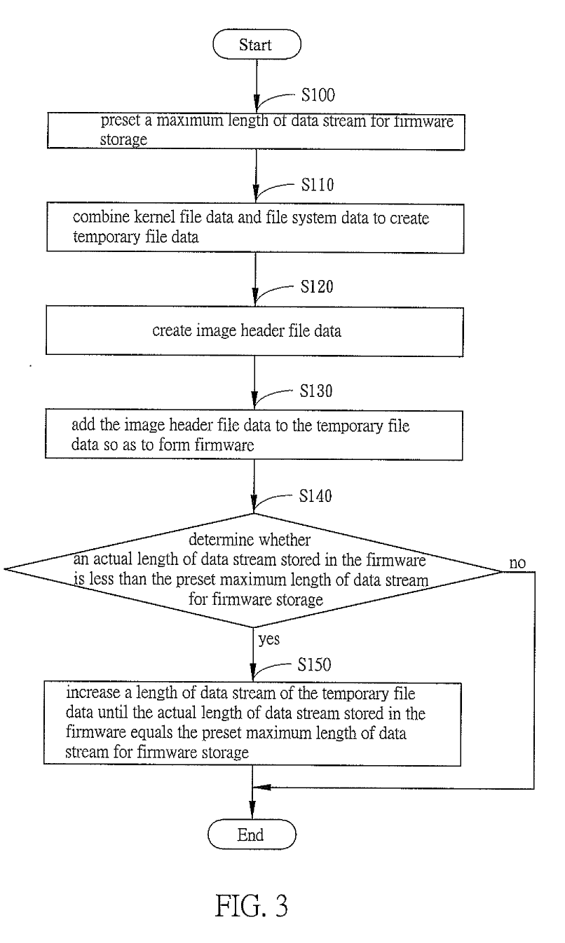

FIG. 3 is a flow diagram showing a method of creating firmware for use with the system of updating firmware. In the present embodiment, the method of creating firmware is applied to the server end and completed by manufacturers so as to create new firmware to be used for updating by users. As shown in the drawing, first, at step S100, a maximum length of the data stream for firmware storage is preset. Then, the process goes to step S110.

At step S110, kernel file data and file system data are combined so as to create temporary file data. Then, the process goes to step S120.

At step S120, image header file data is created, which at least comprises a cyclic redundancy checksum and the image header file creation time. In the present embodiment, the image header file data further comprises identification code information. The cyclic redundancy checksum comprises header checksum information, data stream length information, and data checksum information. Then, the process goes to step S130.

It should be noted that the firmware update files at least comprise kernel file data and file system data. The identification code information comprises product serial numbers from manufacturers. The cyclic redundancy checksum is used for determining whether the data stream to which the information belongs has an abnormality. As the technique is well known in the art, detailed description thereof is omitted. Further, the actual length of data stream stored in the kernel file data may be different due to different compiling times and different versions, which affects the configuration of initial bit addresses of the file system data to be combined with the kernel file data. Furthermore, the execution of the file system data generally starts from a fixed start address; therefore, the maximum length of the data stream of the kernel file data is further preset so as to ensure that the start address of the file system data is at a fixed address section, which is the start address of the kernel data file plus the maximum file size plus 1.

At step S130, the image header file data is added to the temporary file data so as to form firmware for use in the electronic device. Then, the process goes to step S140.

At step S140, determine whether the actual length of the data stream stored in the firmware is less than the preset maximum length of data stream, wherein, if yes, the process goes to step S150, otherwise, the creation of the firmware is completed.

At step S150, the length of the temporary file data is increased until the actual length of the firmware meets the preset maximum file size, thereby completing the creating of firmware.

As described above, the system and method of updating firmware and the method of creating firmware are provided by the present invention, which mainly comprises: obtaining new firmware upon receiving an instruction for executing a firmware update; determining whether the cyclic redundancy checksum of the new firmware coincides with the application, wherein, if yes, determine whether the first firmware and the second firmware are abnormality-stricken according to the cyclic redundancy checksum of the first firmware and the second firmware, wherein, if one of the first firmware and the second firmware is abnormality-stricken, lock the abnormality-stricken firmware as target firmware, and if both the first firmware and the second firmware are abnormality-free, compare the image header file creation time of the first firmware with that of the second firmware so as to lock the firmware with earlier image header file creation time as target firmware, but if both the first firmware and the second firmware are abnormality-stricken, end the firmware updating process; finally, replace the target firmware with the new firmware.

Therefore, the present invention chooses abnormality-stricken firmware or abnormality-free firmware with earlier image header file creation time for updating, thereby allowing the electronic device to keep the latest version of firmware. If the firmware updating process is successful, the electronic device chooses the latest version of firmware according to the image header file creation time for execution. Otherwise, if the firmware updating process fails, the electronic device executes the firmware with earlier image header file creation time, thereby preventing the electronic device from failing to operate due to the failed firmware updating process, overcoming inconvenience for users and manufactures that exists in the prior art.

The aforementioned descriptions of the detailed embodiment is supplied to illustrate the preferred implementation according to the present invention, and should not be construed so as to limit the scope of the present invention, Accordingly, various modifications and variations completed by those with ordinary skill in the art should fall within the scope of present invention as defined by the appended claims.

What is claimed is:

1. A system of updating firmware, wherein the system allows a firmware updating operation to be performed on firmware stored in an electronic device, the system comprising:
a firmware storage module disposed in the electronic device for at least storing a first firmware version and a second firmware version, wherein the first firmware version and the second firmware version each have image header file data comprising a cyclic redundancy checksum and an image header file creation time;
a receiving module for receiving an instruction for executing a firmware update so as to obtain new firmware;
a determining module for (a) receiving the instruction for executing a firmware update, (b) determining whether the new firmware obtained by the receiving module has an abnormality according to the cyclic redundancy checksum in the new firmware, (c) ending the firmware updating operation upon a determination being made of the presence of an abnormality in the new firmware, (d) determining whether the first firmware version and the second firmware version stored in the firmware storage module have an abnormality according to the cyclic redundancy checksum in the first firmware and the second firmware upon determining absence of an abnormality in the new firmware, (e) locking, upon determination of the presence of an abnormity in one version of the first firmware and the second firmware, the abnormality-stricken firmware as target firmware, (f) comparing, upon determination of absence of any abnormity in the first firmware and the second firmware, the first firmware with the second firmware in terms of the image header file creation time thereof so as to define target firmware for replacement by locking the first firmware or the second firmware, whichever has the earlier said image header file creation time, and (g) ending the firmware updating operation upon determination of the presence of an abnormality in the first firmware and the second firmware; and
an updating module for replacing the target firmware locked for replacement by the determining module with the new firmware so as to complete performing the firmware updating operation on firmware stored in the electronic device.

2. The system of claim 1, further comprising a firmware executing module for re-executing executable firmware in the electronic device.

3. The system of claim 2, wherein the determining module further (a) determines, before the firmware executing module re-executes the executable firmware, whether the first firmware and the second firmware have an abnormality after the firmware updating operation according to the cyclic redundancy checksum of the first firmware and the second firmware stored in the firmware storage module so as to lock, upon determination of presence of an abnormality in one version of the first firmware and the second firmware, the abnormality-free firmware as executable firmware, (b) compares, upon determination of absence of abnormity in the first firmware and the second firmware, the first firmware with the second firmware in terms of the image header file creation time thereof so as to define the executable firmware by locking the first firmware or the second firmware, whichever has the later said image header file creation time, and (c) ends system startup upon determination of presence of the abnormality in the first firmware and the second firmware.

4. The system of claim 1, wherein the cyclic redundancy checksum comprises header checksum information, data stream length information, and data checksum information.

5. The system of claim 1, wherein the firmware storage module is one of a flash ROM and an EEPROM.

6. The system of claim 1, wherein the new firmware is obtained by one of network transmission, CD-ROM reading, and USB reading.

7. A method of updating firmware, wherein the method allows a firmware updating operation to be performed on firmware stored in an electronic device having a firmware storage module stored with a first firmware version and a second firmware version each at least having image header file data comprising a cyclic redundancy checksum and an image header file creation time, the method comprising the steps of:
obtaining new firmware upon receipt of an instruction for executing a firmware update;
checking the cyclic redundancy checksum of the new firmware for an error, and going to the next step upon determination that the cyclic redundancy checksum of the new firmware is error-free;
determining whether the first firmware and the second firmware have an abnormality according to the cyclic redundancy checksum of the first firmware and the second firmware so as to lock, upon determination of the presence of an abnormality in one of the first firmware and the second firmware, the abnormality-stricken firmware as target firmware for replacement, and comparing, upon determination of the absence of abnormity in the first firmware and the second firmware, the first firmware with the second firmware in terms of the image header file creation time thereof so as to define target firmware by locking the first firmware or the second firmware, whichever has earlier said image header file creation time, and ending the firmware updating operation upon determination of the presence of an abnormality in both the first firmware and the second firmware; and
replacing the locked target firmware with the new firmware so as to complete performing the firmware updating operation on firmware stored in the electronic device.

8. The method of claim 7, wherein, after replacing the locked target firmware with the new firmware, the method further comprises the step of:
restarting the electronic device and determining whether the first firmware and the second firmware have an abnormality according to the cyclic redundancy checksum of the first firmware and the second firmware so as to execute, upon determination of the presence of an abnormality in one of the first firmware and the second firmware, the abnormality-free firmware, and comparing, upon determination of absence of the abnormity in the first firmware and the second firmware, the first firmware with the second firmware in terms of the image header file creation time thereof so as to execute the first firmware or the second firmware, whichever has the later said image header file creation time, and ending the firmware startup procedure upon determination of the presence of an abnormality in both the first firmware and the second firmware.

9. The method of claim 7, wherein the cyclic redundancy checksum comprises header checksum information, data stream length information, and data checksum information.

10. The method of claim 7, wherein the image header file data further comprises identification code information such that another version of the new firmware is obtained anew when the identification code information of the new firmware is compared with and therefore determined to be different from the identification code information of the first firmware or the second firmware.

11. The method of claim 10, wherein, before the step of comparing the identification code information, the method further comprises the step of:
determining whether the new firmware has an abnormality according to the cyclic redundancy checksum of the new firmware so as to end the firmware updating operation upon determination of the presence of an abnormality in the new firmware and proceeding to the step of comparing the identification code information upon determination of absence of the abnormality in the new firmware.

12. The method of claim 11, wherein the identification code information comprises product serial numbers from manufacturers.

13. The method of claim 7, wherein the new firmware is obtained by one of network transmission, CD-ROM reading, and USB reading.

14. A method of creating firmware for use with a system of updating firmware, comprising:
presetting a maximum length of a data stream for firmware storage;
combining kernel file data and file system data to create temporary file data;
creating image header file data comprising a cyclic redundancy checksum and an image header file creation time;
adding the image header file data to the temporary file data so as to form firmware; and
determining whether the actual length of the data stream stored in the firmware is less than the preset maximum length of the data stream for firmware storage so as to increase, upon affirmative determination, the length of the data stream of the temporary file data until the actual length of the data stream stored in the firmware equals the preset maximum length of the data stream for firmware storage.

15. The method of claim 14, wherein the image header file data further comprises identification code information.

16. The method of claim 14, wherein the cyclic redundancy checksum comprises header checksum information, data stream length information, and data checksum information.
